(19) United States
(12) Patent Application Publication
(10) Pub. No.: US 2022/0402311 A1
(43) Pub. Date: Dec. 22, 2022

(54) PNEUMATIC TIRE

(71) Applicant: The Yokohama Rubber Co., LTD., Tokyo (JP)

(72) Inventors: Masahiro NARUSE, Kanagawa (JP); Yuki NAGAHASHI, Kanagawa (JP)

(21) Appl. No.: 17/756,298

(22) PCT Filed: Nov. 25, 2020
(86) PCT No.: PCT/JP2020/043764

§ 371 Date: May 20, 2022

(30) Foreign Application Priority Data
Nov. 27, 2019 (JP) 2019-214372

(51) Int. Cl. B60C 19/00; B60C 15/00

(52) U.S. Cl. CPC B60C 19/00; B60C 15/0045

(57) ABSTRACT

In a pneumatic tire in which a carcass layer is turned up from a tire inner side to a tire outer side around a bead core, an end of a turned up portion of the carcass layer is disposed between a body portion of the carcass layer and a belt layer, a transponder that extends along time circumferential direction is embedded between the turned up portion of the carcass layer and a rubber layer disposed in a sidewall portion on an outer side of the carcass layer, and the transponder is disposed between a position (P1) located on an outer side of and 15 mm away from an upper end of the bead core in a tire radial direction and a position (P2) located on an inner side of and 5 mm away from an end of the belt layer in the tire radial direetion

### TECHNICAL FIELD

The present technology relates to a pneumatic tire embedded with a transponder, and relates particularly to a pneumatic tire that enables steering stability and durability of the tire to be improved while ensuring communication performance of the transponder.

### BACKGROUND ART

For pneumatic tires, embedment of an RFID (radio frequency identification) tag (transponder) in a tire has been proposed (see, for example, Japan Unexamined Patent Publication No. H07-137510). A transponder embedded in the tire poses a problem in that, for example, in a case where the transponder is disposed between a carcass layer and a bead filler, a carcass line of the carcass layer is disturbed, degrading steering stability of the tire. Additionally, depending on an end position of the turned up portion of the carcass layer, the distance between the transponder and the end of a turned up portion of the carcass layer may be extremely small, causing the tire to suffer from damage originating from the transponder. Furthermore, the transponder disposed near a metal tire component (e.g., a bead core or the like) poses a problem in that the tire component and the transponder interfere with each other, degrading communication performance of the transponder.

### SUMMARY

The present technology provides a pneumatic tire that enables steering stability and durability of the tire to be improved while ensuring communication performance of a transponder.

Furthermore, a pneumatic tire according to an embodiment of the present technology includes a tread portion extending in a tire circumferential direction and having an annular shape, a pair of sidewall portions respectively disposed on both sides of the tread portion, and a pair of bead portions each disposed on an inner side of the sidewall portions in a tire radial direction, a bead filler being disposed on an outer circumference of a bead core of each bead portion, a carcass layer being mounted between the pair of bead portions, a plurality of belt layers being disposed on an outer circumferential side of the carcass layer in the tread portion, and the carcass layer being turned up from a tire inner side to a tire outer side around the bead core, an end of a turned up portion of the carcass layer being disposed between a body portion of the carcass layer and the belt layer, a transponder that extends along the tire circumferential direction being embedded between the turned up portion of the carcass layer and a rubber layer disposed in the sidewall portion on an outer side of the carcass layer, and the transponder being disposed between a position located on an outer side of and 15 mm away from an upper end of the bead core in the tire radial direction and a position located on an inner side of and 5 mm away from an end of the belt layer in the tire radial direction.

In an embodiment of the present technology, in the pneumatic tire in which the carcass layer is turned up from the tire inner side to the tire outer side around the bead core of each bead portion, the end of the turned up portion of the carcass layer is disposed between the body portion of the carcass layer and the belt layer, and the transponder that extends along the tire circumferential direction is embedded between the turned up portion of the carcass layer and the rubber layer disposed in the sidewall portion on the outer side of the carcass layer. This prevents a carcass line from being disturbed by the arrangement of the transponder, allowing the steering stability of the tire to be improved. Additionally, the transponder is disposed between the position located on the outer side of and 15 mm away from the upper end of the bead core in the tire radial direction and the position located on the inner side of and 5 mm away from the end of the belt layer in the tire radial direction. This makes metal interference less likely to occur, allowing the communication performance of the transponder to be ensured. Furthermore, the distance between the transponder and the end of the turned up portion of the carcass layer can be sufficiently ensured and the tire damage originating from the transponder can be prevented, allowing the durability of the tire to be improved.

In the pneumatic tire of an embodiment of the present technology, preferably, the transponder is disposed between the position located on the outer side of and 15 mm away from the upper end of the bead core in the tire radial direction and an upper end of the bead filler in the tire radial direction. Accordingly, the transponder is disposed in a region lateral to the bead filler. This region is subjected to little tire deformation during traveling, thus reducing a load on the transponder to allow damage to the transponder to be prevented. Additionally, the tire suffers from no damage originating from the transponder, and the communication performance of the transponder can also be ensured.

Preferably, the transponder is disposed between a position located on an outer side of and 5 mm away from an upper end of the bead filler in the tire radial direction and a position located on the inner side of and 5 mm away from the end of the belt layer in the tire radial direction. Accordingly, the transponder is disposed in a flex zone with a small rubber gauge. However, this region is subjected to less attenuation of radio waves during communication of the transponder, allowing the communication performance of the transponder to be effectively improved.

Preferably, a center of the transponder is disposed 10 mm or more away from a splice portion of a tire component in the tire circumferential direction. Accordingly, tire durability can be effectively improved.

Preferably, a distance between a cross-sectional center of the transponder and a tire outer surface is 2 mm or more. Accordingly, tire durability can be effectively improved, and tire scratch resistance can be improved.

Preferably, the transponder is covered with a coating layer, and the coating layer has a relative dielectric constant of 7 or less. Accordingly, the transponder is protected by the coating layer, allowing the durability of the transponder to be improved and also ensuring radio wave transmissivity of the transponder to allow the communication performance of the transponder to be effectively improved.

Preferably, the transponder is covered with a coating layer, and the coating layer has a thickness of from 0.5 mm to 3.0 mm. Accordingly, the communication performance of the transponder can be effectively improved without making the tire outer surface uneven.

Preferably, the transponder includes an IC (integrated circuit) substrate storing data and an antenna transmitting and receiving data, and the antenna has a helical shape. Accordingly, it can conform deformation of the tire during traveling, allowing the durability of the transponder to be improved.

### BRIEF DESCRIPTION OF DRAWINGS

FIG. 1 is a meridian cross-sectional view illustrating the pneumatic tire according to an embodiment of the present technology.

FIG. 2 is a meridian cross-sectional view schematically illustrating the pneumatic tire of FIG. 1.

FIG. 3 is a equator line cross-sectional view schematically illustrating the pneumatic tire of FIG. 1.

FIG. 4 is an enlarged cross-sectional view illustrating a transponder embedded in the pneumatic tire of FIG. 1.

FIGS. 5A and 5B are perspective views illustrating a transponder that can be embedded in a pneumatic tire according to an embodiment of the present technology.

FIG. 6 is an explanatory diagram illustrating the position of a transponder or an end of a turned up portion of a carcass layer in a tire radial direction in a test tire.

### DETAILED DESCRIPTION

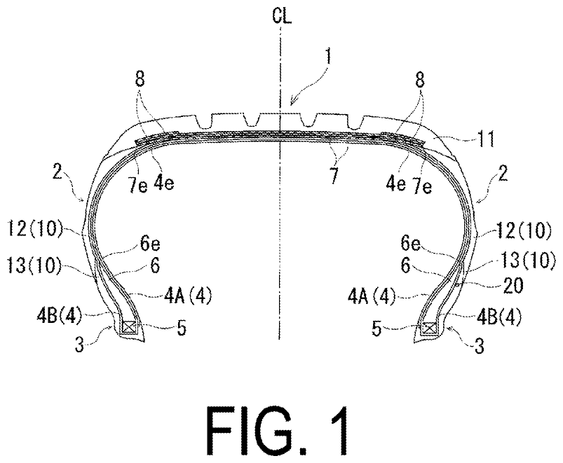

Configurations of embodiments of the present technology will be described in detail below with reference to the accompanying drawings. FIGS. 1 to 4 illustrate a pneumatic tire according to an embodiment of the present technology.

As illustrated in FIG. 1, the pneumatic tire according to the present embodiment includes a tread portion 1 extending in a tire circumferential direction and having an annular shape, a pair of sidewall portions 2 disposed on both sides of the tread portion 1, and a pair of bead portions 3 disposed on an inner side in a tire radial direction of the pair of sidewall portions 2.

At least one carcass layer 4 (one layer in FIG. 1) formed by arranging a plurality of carcass cords in the radial direction is mounted between the pair of bead portions 3. Organic fiber cords of nylon, polyester, or the like are preferably used as the carcass cords constituting the carcass layer 4. Bead cores 5 having an annular shape are embedded within the bead portions 3, and bead fillers 6 made of a rubber composition and having a triangular cross-section are disposed on the outer peripheries of the bead cores 5.

On the other hand, a plurality of belt layers 7 (two layers in FIG. 1) are embedded on a tire outer circumferential side of the carcass layer 4 of the tread portion 1. The belt layers 7 include a plurality of reinforcing cords that are inclined with respect to the tire circumferential direction, and the reinforcing cords are disposed between layers so as to intersect each other. In the belt layers 7, the inclination angle of the reinforcing cords with respect to the tire circumferential direction is set to fall within a range of from 10° to 40°, for example. Steel cords are preferably used as the reinforcing cords of the belt layers 7.

To improve high-speed durability, at least one belt cover layer 8 (two layers in FIG. 1) formed by arranging reinforcing cords at an angle of, for example, 5° or less with respect to the tire circumferential direction is disposed on a tire outer circumferential side of the belt layers 7. In FIG. 1, the belt cover layer 8 located on the inner side in the tire radial direction constitutes a full cover that covers the entire width of the belt layers 7, and the belt cover layer 8 located on an outer side in the tire radial direction constitutes an edge cover layer that covers only end portions of the belt layers 7. Organic fiber cords such as nylon and aramid are preferably used as the reinforcing cords of the belt cover layer 8.

In the pneumatic tire described above, both ends 4e of the carcass layer 4 are folded back from the tire inner side to the tire outer side around the bead cores 5, and are disposed wrapping around the bead cores 5 and the bead fillers 6. The carcass layer 4 includes, a body portion 4A corresponding to a portion extending from the tread portion 1 through each of the sidewall portions 2 to each of the bead portions 3; and a turned up portion 4B corresponding to a portion turned up around the bead core 5 at each of the bead portions 3 and extending toward each sidewall portion 2 side. The end 4e of the turned up portion 4B of the carcass layer 4 is disposed between the body portion 4A of the carcass layer 4 and the belt layer 7.

Additionally, a cap tread rubber layer 11 is disposed in the tread portion 1, a sidewall rubber layer 12 is disposed in the sidewall portion 2, and a rim cushion rubber layer 13 is disposed in the bead portion 3. A rubber layer 10 disposed on the outer side of the carcass layer 4 in the sidewall portion 2 includes the sidewall rubber layer 12 and the rim cushion rubber layer 13.

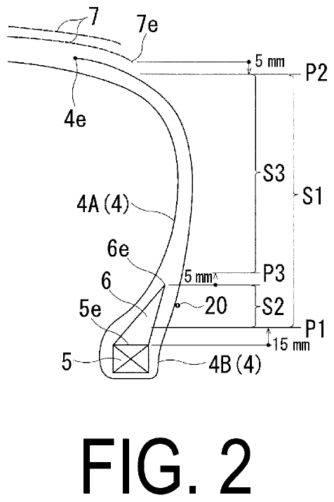

Additionally, in the pneumatic tire described above, a transponder 20 is embedded between the turned up portion 4B of the carcass layer 4 and the rubber layer 10. In other words, the transponder 20 is disposed between the turned up portion 4B of the carcass layer 4 and the sidewall rubber layer 12 or the rim cushion rubber laver 13 as an arrangement region in the tire width direction. Additionally, as an arrangement region in the tire radial direction, the transponder 20 is disposed between a position P1 located on the outer side of and 15 mm away from an upper end 5e of the bead core 5 in the tire radial direction (an end portion on the outer side in the tire radial direction) and a position P2 located on the inner side of and 5 mm away from an end 7e of the belt layer 7 in the tire radial direction. In other words, the transponder 20 is disposed in a region S1 illustrated in FIG. 2. Additionally, the transponder 20 extends in the tire circumferential direction. The transponder 20 may be disposed inclined at an angle ranging from −10° to 10° with respect to the tire circumferential direction.

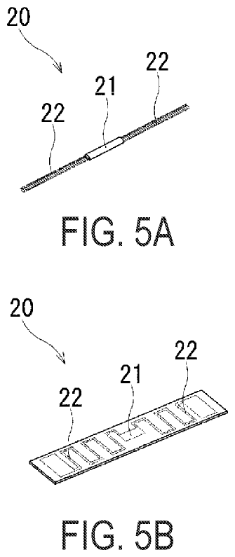

As the transponder 20, for example, a radio frequency identification (RFID) tag can be used. As illustrated in FIGS. 5A and 5B, the transponder 20 includes an IC substrate 21 that stores data and an antenna 22 that transmits and receives data in a non-contact manner. By using the transponder 20 as described above to write or read information related to the tire on a timely basis, the tire can be efficiently managed. Note that “RFID” refers to an automatic recognition technology including: a reader/writer including an antenna and a controller; and an ID (identification) tag including an IC substrate and an antenna, the automatic recognition technology allowing data to be communicated in a wireless manner.

The overall shape of the transponder 20 is not particularly limited, and for example, a pillar- or plate-like shape can be used as illustrated in FIGS. 5A and 5B. In particular, the transponder 20 having a pillar-like shape illustrated in FIG. 5A is suitable as it can conform deformation of the tire in many directions. In this case, the antenna 22 of the transponder 20 projects from each of both end portions of the IC substrate 21 and exhibits a helical shape. Accordingly, the transponder 20 can conform deformation of the tire during traveling, allowing the durability of the transponder 20 to be improved. Furthermore, by appropriately changing the length of the antenna 22, the communication performance can be ensured.

In the pneumatic tire described above, the end 4e of the turned up portion 4B of the carcass layer 4 is disposed between the body portion 4A of the carcass layer 4 and the belt layer 7, and the transponder 20 extending along the tire circumferential direction is embedded between the turned up portion 4B of the carcass layer 4 and the rubber layer 10 disposed on the outer side of the carcass layer 4 in the sidewall portion 2. Thus, the arrangement of the transponder 20 does not disturb a carcass line, allowing the steering stability of the tire to be improved. Additionally, the transponder 20 is embedded between the position P1 located on the outer side of and 15 mm away from the upper end 5e of the bead core 5 in the tire radial direction and the position P2 located on the inner side of and 5 mm away from the end 7e of the belt laver 7 in the tire radial direction, thus making metal interference less likely to occur to allow the communication performance of the transponder 20 to be ensured. Furthermore, the distance between the transponder 20 and the end 4e of the turned up portion 4B of the carcass layer 4 is sufficiently ensured, preventing the tire damage originating from the transponder 20, thus allowing the durability of the tire to be improved.

In this regard, in a case where the transponder 20 is disposed further on the inner side than the position P1 in the tire radial direction, metal interference with the rim flange occurs, leading to the tendency to degrade the communication performance of the transponder 20. Additionally, in a case where the transponder 20 is disposed further on the outer side than the position P2 in the tire radial direction, metal interference with the belt layer occurs, leading to the tendency to degrade the communication performance of the transponder 20.

In the pneumatic tire described above, the transponder 20 may be disposed between the position P1 located on the outer side of and 15 mm away from the upper end 5e of the bead core 5 in the tire radial direction and an upper end 6e of the bead filler 6 (an end portion on the outer side in the tire radial direction). In other words, the transponder 20 may be disposed in a region S2 illustrated in FIG. 2. The region S2 is a region subjected to little tire deformation during traveling, and the transponder 20 disposed in the region S2 reduces a load on the transponder 20, preventing damage to the transponder 20. Additionally, the tire suffers from no damage originating from the transponder 20, and can ensure the communication performance of the transponder 20.

Alternatively, the transponder 20 may be disposed between a position P3 located on the outer side of and 5 mm away from the upper end 6e of the bead filler 6 in the tire radial direction and the position P2 located on the inner side of and 5 mm away from the end 7e of the belt layer 7 in the tire radial direction. In other words, the transponder 20 may be disposed in a region S3 illustrated in FIG. 2. The region S3 is a flex zone with a small rubber gauge, and the transponder 20 disposed in the region S3 is subjected to less attenuation of radio waves during communication of the transponder 20, allowing the communication performance of the transponder 20 to be effectively improved.

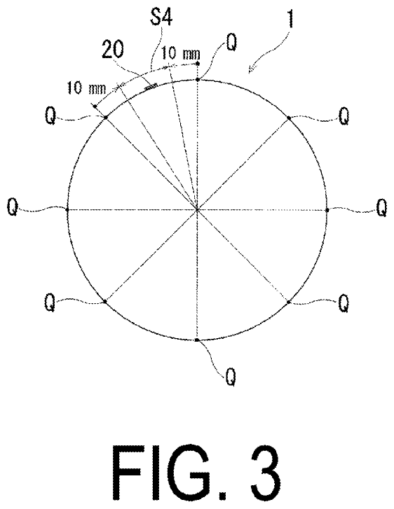

As illustrated in FIG. 3, a plurality of splice portions formed by overlaying end portions of the tire component are present on the tire circumference. FIG. 3 illustrates positions Q of each of the splice portions in the tire circumferential direction. The center of the transponder 20 is preferably disposed 10 mm or more away from the splice portion of the tire component in the tire circumferential direction. In other words, the transponder 20 may be disposed in a region S4 illustrated in FIG. 3. Specifically, the IC substrate 21 constituting the transponder 20 may be located 10 mm or more away from the position Q in the tire circumferential direction. Furthermore, the entire transponder 20 including the antenna 22 is more preferably located 10 mm or more away from the position Q in the tire circumferential direction, and the entire transponder 20 covered with the coating rubber is most preferably located 10 mm or more away from the position Q in the tire circumferential direction. Additionally, the tire component disposed away from the transponder 20 is preferably the sidewall rubber layer 12 or the rim cushion rubber layer 13, or the carcass layer 4, which are disposed adjacent to the transponder 20. By disposing the transponder 20 away from the splice portion of the tire component as described above, tire durability can be effectively improved.

Note that in the embodiment of FIG. 3, an example in which the positions Q of the splice portions of each tire component in the tire circumferential direction are disposed at equal intervals, but no such limitation is intended. The positions Q in the tire circumferential direction can be set at any positions, and in either case, the transponder 20 is disposed 10 mm or more away from the splice portion of each tire component in the tire circumferential direction.

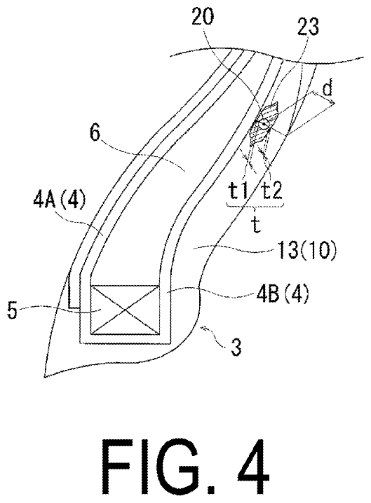

As illustrated in FIG. 4, a distance d between the cross-sectional center of the transponder 20 and the tire outer surface is preferably 2 mm or more. By spacing the transponder 20 and the tire outer surface apart from each other as described above, tire durability can be effectively improved, and tire scratch resistance can be improved.

Additionally, the transponder 20 may be covered with a coating layer 23. The coating layer 23 coats the entire transponder 20 while holding both front and rear sides of the transponder 20. The coating layer 23 may be formed from rubber having physical properties identical to those of the rubber constituting the sidewall rubber layer 12 or the rim cushion rubber layer 13 or from rubber having different physical properties. The transponder 20 is protected by the coating layer 23 as described above, and thus the durability of the transponder 20 can be improved.

In the pneumatic tire described above, with the transponder 20 covered with the coating layer 23, the coating layer 23 preferably has a relative dielectric constant of 7 or less and more preferably from 2 to 5. By properly setting the relative dielectric constant of the coating layer 23 as described above, radio wave transmissivity can be ensured during emission of a radio wave by the transponder 20, effectively improving the communication performance of the transponder 20. Note that the rubber constituting the coating layer 23 has a relative dielectric constant of from 860 MHz to 960 MHz at ambient temperature. In this regard, the ambient temperature is 23±2° C. and 60%+5% RH (relative humidity) in accordance with the standard conditions of the JIS (Japanese Industrial Standard) standard. The relative dielectric constant of the rubber is measured after 24 hour treatment at 23° C. and 60% RH. The range from 860 MHz to 960 MHz described above corresponds to the allocated frequency of the RFID in the current UHF (ultra-high frequency) band, but in a case where the allocated frequency is changed, the relative dielectric constant in the range of the allocated frequency may be specified as described above.

In addition, with the transponder 20 covered with the coating layer 23, a thickness t of the coating layer 23 preferably ranges from 0.5 mm to 3.0 mm, and more preferably ranges from 1.0 mm to 2.5 mm. In this regard, the thickness t of the coating layer 23 is the thickness of the rubber at a position where the rubber includes the transponder 20, and is, for example, a rubber thickness obtained by summing a thickness t1 and a thickness t2 on a straight line extending through the center of the transponder 20 and orthogonally to the tire outer surface as illustrated in FIG. 4. By properly setting the thickness t of the coating layer 23 as described above, the communication performance of the transponder 20 can be effectively improved without making the tire outer surface uneven. In this regard, when the thickness t of the coating layer 23 is less than 0.5 mm, the effect of improving the communication performance of the transponder 20 fails to be obtained. In contrast, when the thickness t of the coating layer 23 exceeds 3.0 mm, the tire outer surface is uneven, and this is not preferable for appearance. Note that the cross-sectional shape of the coating layer 23 is not particularly limited and that for example, a triangular shape, a rectangular shape, a trapezoidal shape, and a spindle shape can be adopted. The coating layer 23 in FIG. 4 has a substantially spindle-shaped cross-sectional shape.

In the embodiment described above, an example of a pneumatic tire including a single carcass layer is illustrated. However, no such limitation is intended, and the pneumatic tire may include two carcass layers. In this case, the pneumatic tire has a structure in which the end of the turned up portion of the carcass layer located in the sidewall portion on the outermost side in the tire width direction is disposed between the body portion of the carcass layer and the belt layer.

### Example

Tires according to Comparative Examples 1 to 5 and Examples 1 to 18 were manufactured. The tires have a tire size of 265/40ZR20 and include a tread portion extending in the tire circumferential direction and having an annular shape, a pair of sidewall portions respectively disposed on both sides of the tread portion, and a pair of bead portions each disposed on an inner side of the sidewall portions in the tire radial direction, a bead filler being disposed on an outer circumference of a bead core of each bead portion, a carcass layer being mounted between the pair of bead portions, a plurality of belt layers being disposed on an outer circumferential side of the carcass layer in the tread portion, and the carcass layer being turned up from the tire inner side to the tire outer side around the bead core, in which a transponder extending along the tire circumferential direction is embedded and in which the position of the transponder (tire width direction, tire radial direction, and tire circumferential direction), the end position of the turned up portion, the distance between the transponder and the tire outer surface, the relative dielectric constant of a coating layer, the thickness of the coating layer, and the form of the transponder are set as indicated in Tables 1 and 2.

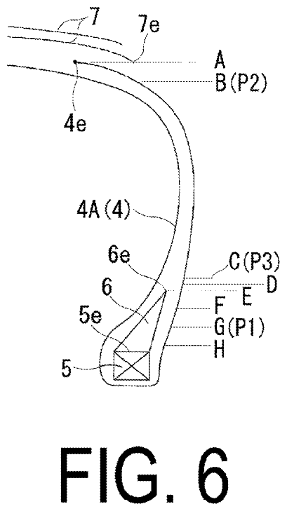

Note that in Tables 1 and 2, the position “X” of the transponder (in the tire width direction) indicates that the transponder is disposed between the bead filler and the carcass layer, the position “Y” of the transponder (in the tire width direction) indicates that the transponder is disposed between the turned up portion of the carcass layer and the sidewall rubber layer, and the position “Z” of the transponder (in the tire width direction) indicates that the transponder is disposed between the turned up portion of the carcass layer and the rim cushion rubber layer. Additionally, in Tables 1 and 2, the position of the transponder (tire radial direction) and the end position of the turned up portion correspond to each of the positions A to H illustrated in FIG. 6. In FIG. 6, an example is used in which the end position of the turned up portion is “A.” Furthermore, in Tables 1 and 2, the position of the transponder (tire circumferential direction) indicates the distance (mm) measured from the center of the transponder to the splice portion of the tire component in the tire circumferential direction.

Tire evaluation (steering stability, durability, scratch resistance, an d appearance) and transponder evaluation (communication performance and durability) were conducted on the test tires using a test method described below, and the results are indicated in Tables 1 and 2.

Steering Stability (Tire):

Each test tire was mounted on a wheel with a standard rim, the wheel was mounted on a test vehicle, and sensory evaluation by a test driver was conducted on a test course. The evaluation results are expressed as three levels: “Excellent” indicates that the result is very good, “Good” indicates that the result is good, and “Fair” indicates that the result is slightly inferior.

Durability (Tire and Transponder):

Each of the test tires was mounted on a wheel of a standard rim, and a traveling test was performed by using a drum testing machine at an air pressure of 120 kPa, 102% of the maximum load, and a traveling speed of 81 km/h. After the test was performed, the traveling distance at the time of occurrence of a failure in the tire was measured. Evaluation results are expressed as four levels: “Excellent” indicates that the traveling distance reached 6480 km, “Good” indicates that the traveling distance was 4050 km or more and less than 6480 km, “Fair” indicates that the traveling distance was 3240 km or more and less than 4050 km, and “Poor” indicates that the traveling distance was less than 3240 km. Furthermore, after traveling was ended, the tire outer surface of each test tire was visually checked, and whether the tire failure originated from the transponder was checked. Evaluation results indicate the presence of the failure.

Scratch Resistance (Tire):

Each test tire was assembled on a wheel of a standard rim and mounted on a test vehicle, and a traveling test was conducted in which the vehicle traveled at an air pressure of 230 kPa and a traveling speed of 20 km/h while being in contact with a curb of 100 mm in height. After traveling, the presence of damage to the tire outer surface was visually checked. Evaluation results indicate the presence of damage to the tire outer surface.

Appearance (Tire):

For each test tire, the portion of the tire outer surface corresponding to the arrangement section for the transponder was visually checked. In the evaluation results. “Good” indicates that the tire outer surface had no unevenness caused by the arrangement of the transponder, and “Poor” indicates that the tire outer surface had unevenness.

Communication Performance (Transponder):

For each test tire, a communication operation with the transponder was performed using a reader/writer. Specifically, the maximum communication distance was measured with the reader-writer set at a power output of 250 mW and a carrier frequency of from 860 MHz to 960 MHz. The evaluation results are expressed as three levels: “Excellent” indicates that the communication distance is 500 mm or more, “Good”, indicates that the communication distance is 150 mm or more and less than 500 mm, and “Fair” indicates that the communication distance is less than 150 mm.

TABLE 1

| | | Comparative | Comparative | Comparative | Comparative |
|---|---|---|---|---|---|
| | | Example 1 | Example 2 | Example 3 | Example 4 |
| Position of | Tire width direction | X | Z | Z | Z |
| transponder | Tire radial direction | D | H | H | D |
| | Tire circumferential | 2 | 2 | 2 | 2 |
| | direction | | | | |
| End position of turned up portion | | A | D | A | D |
| Distance between transponder | | 2 or more | 2 or more | 2 or more | 2 or more |
| and tire outer surface (mm) | | | | | |
| Relative dielectric constant of coating layer | | — | — | — | — |
| Thickness of coating layer (mm) | | — | — | — | — |
| Form of transponder | | Plate-like | Plate-like | Plate-like | Plate-like |
| | | shape | shape | shape | shape |
| Tire | Steering stability | Fair | Good | Good | Good |
| evaluation | Durability | Good | Fair | Good | Fair |
| | Scratch Resistance | No | No | No | No |
| | (presence of damage) | | | | |
| | Appearance | — | — | — | — |
| Transponder | Communication | Good | Fair | Fair | Good |
| evaluation | performance | | | | |
| | Durability | Yes | Yes | Yes | Yes |
| | (presence of | | | | |
| | failure) | | | | |

| | | Comparative | Example | Example | Example |
|---|---|---|---|---|---|
| | | Example 5 | 1 | 2 | 3 |
| Position of | Tire width direction | Y | Y | Z | Z |
| transponder | Tire radial direction | A | D | G | F |
| | Tire circumferential | 2 | 2 | 2 | 2 |
| | direction | | | | |
| End position of turned up portion | | A | A | A | A |
| Distance between transponder | | 2 or more | 2 or more | 2 or more | 2 or more |
| and tire outer surface (mm) | | | | | |
| Relative dielectric constant of coating layer | | — | — | — | — |
| Thickness of coating layer (mm) | | — | — | — | — |
| Form of transponder | | Plate-like | Plate-like | Plate-like | Plate-like |
| | | shape | shape | shape | shape |
| Tire | Steering stability | Good | Good | Good | Good |
| evaluation | Durability | Good | Good | Good | Good |
| | Scratch Resistance | No | No | No | No |
| | (presence of damage) | | | | |
| | Appearance | — | — | — | — |
| Transponder | Communication | Fair | Good | Good | Good |
| evaluation | performance | | | | |
| | Durability (presence of | Yes | Yes | No | No |
| | failure) | | | | |

| | | Example | Example | Example | Example |
|---|---|---|---|---|---|
| | | 4 | 5 | 6 | 7 |
| Position of | Tire width direction | Z | Y | Y | Z |
| transponder | Tire radial direction | E | C | B | D |
| | Tire circumferential | 2 | 2 | 2 | 5 |
| | direction | | | | |
| End position of turned up portion | | A | A | A | A |
| Distance between transponder | | 2 or more | 2 or more | 2 or more | 2 or more |
| and tire outer surface (mm) | | | | | |
| Relative dielectric constant of coating layer | | — | — | — | — |
| Thickness of coating layer (mm) | | — | — | — | — |
| Form of transponder | | Plate-like | Plate-like | Plate-like | Plate-like |
| | | shape | shape | shape | shape |
| Tire | Steering stability | Good | Good | Good | Excellent |
| evaluation | Durability | Good | Good | Good | Good |
| | Scratch Resistance | No | No | No | No |
| | (presence of damage) | | | | |
| | Appearance | — | — | — | — |
| Transponder | Communication | Good | Excellent | Excellent | Good |
| evaluation | performance | | | | |
| | Durability (presence of | No | Yes | Yes | Yes |
| | failure) | | | | |

TABLE 2

| | | Example | Example | Example | Example |
|---|---|---|---|---|---|
| | | 8 | 9 | 10 | 11 |
| Position of | Tire width direction | Z | Z | Z | Z |
| transponder | Tire radial direction | D | D | D | D |
| | Tire circumferential | 10 | 2 | 2 | 2 |
| | direction | | | | |
| End position of turned up portion | | A | A | A | A |
| Distance between transponder | | 2 or more | 1 | 2 or more | 2 or more |
| and tire outer surface (mm) | | | | | |
| Relative dielectric constant of coating layer | | — | — | — | 3.5 |
| Thickness of coating layer (mm) | | — | — | — | 0.2 |
| Form of transponder | | Plate-like | Plate-like | Plate-like | Plate-like |
| | | shape | shape | shape | shape |
| Tire | Steering stability | Excellent | Good | Good | Good |
| evaluation | Durability | Excellent | Good | Good | Good |
| | Scratch Resistance | No | Yes | No | No |
| | (presence of damage) | | | | |
| | Appearance | — | — | — | Good |
| Transponder | Communication | Good | Good | Good | Excellent |
| evaluation | performance | | | | |
| | Durability (presence of | No | Yes | Yes | No |
| | failure) | | | | |
| | | Example | Example | Example | Example |
| | | 12 | 13 | 14 | 15 |
| Position of | Tire width direction | Z | Z | Z | Z |
| transponder | Tire radial direction | D | D | D | D |
| | Tire circumferential | 2 | 2 | 2 | 2 |
| | direction | | | | |
| End position of turned up portion | | A | A | A | A |
| Distance between transponder | | 2 or more | 2 or more | 2 or more | 2 or more |
| and tire outer surface (mm) | | | | | |
| Relative dielectric constant of coating layer | | 7 | 8 | 7 | 7 |
| Thickness of coating layer (mm) | | 0.2 | 0.2 | 0.5 | 1.5 |
| Form of transponder | | Plate-like | Plate-like | Plate-like | Plate-like |
| | | shape | shape | shape | shape |
| Tire | Steering stability | Good | Good | Good | Good |
| evaluation | Durability | Good | Good | Good | Good |
| | Scratch Resistance | No | No | No | No |
| | (presence of damage) | | | | |
| | Appearance | Good | Good | Good | Good |
| Transponder | Communication | Excellent | Good | Excellent | Excellent |
| evaluation | performance | | | | |
| | Durability (presence of | No | No | No | No |
| | failure) | | | | |

| | | Example | Example | Example |
|---|---|---|---|---|
| | | 16 | 17 | 18 |
| Position of | Tire width direction | Z | Z | Z |
| transponder | Tire radial direction | D | D | D |
| | Tire circumferential | 2 | 2 | 2 |
| | direction | | | |
| End position of turned up portion | | A | A | A |
| Distance between transponder | | 2 or more | 2 or more | 2 or more |
| and tire outer surface (mm) | | | | |
| Relative dielectric constant of coating layer | | 7 | 7 | — |
| Thickness of coating layer (mm) | | 3.0 | 3.5 | — |
| Form of transponder | | Plate-like | Plate-like | Pillar-like |
| | | shape | shape | shape |
| Tire | Steering stability | Good | Good | Good |
| evaluation | Durability | Good | Good | Good |
| | Scratch Resistance | No | No | No |
| | (presence of damage) | | | |
| | Appearance | Good | Poor | — |
| Transponder | Communication | Excellent | Excellent | Good |
| evaluation | performance | | | |
| | Durability (presence of | No | No | No |
| | failure) | | | |

As can be seen from Tables 1 and 2, in the pneumatic tires of Examples 1 to 18, the steering stability and durability of the tire and the communication performance of the transponder were improved in a well-balanced manner. In the pneumatic tire of Example 9, the distance between the transponder and the tire outer surface was set to a small value, thus degrading the scratch resistance of the tire. In the pneumatic tire of Example 17, the thickness of the coating layer covering the transponders was set to a large value, thus degrading the appearance of the tire. The pneumatic tire of Example 18 included a pillar-like transponder, thus improving the durability of the transponder to prevent damage originating from the transponder.

On the other hand, in Comparative Example 1, the transponder was disposed between the bead filler and the carcass layer, thus degrading the steering stability of the tire. In Comparative Examples 2 and 3, the position of the transponder in the tire radial direction was set lower than the region specified in an embodiment of the present technology, thus degrading the communication performance of the transponder. In Comparative Examples 2 and 4, the end position of the turned up portion of the carcass layer was set at a low position, thus degrading the durability of the tire. In Comparative Example 5, the position of the transponder in the tire radial direction was set higher than the region specified in an embodiment of the present technology, thus degrading the communication performance of the transponder.

1-8. (canceled)

9. A pneumatic tire comprising:
a tread portion extending in a tire circumferential direction and having an annular shape;
a pair of sidewall portions respectively disposed on both sides of the tread portion; and
a pair of bead portions each disposed on an inner side of the sidewall portions in a tire radial direction,
a bead filler being disposed on an outer circumference of a bead core of each bead portion,
a carcass layer being mounted between the pair of bead portions,
a plurality of belt layers being disposed on an outer circumferential side of the carcass layer in the tread portion, and
the carcass layer being turned up from a tire inner side to a tire outer side around the bead core,
an end of a turned up portion of the carcass layer being disposed between a body portion of the carcass layer and the belt layer,
a transponder that extends along the tire circumferential direction being embedded between the turned up portion of the carcass layer and a rubber layer disposed in the sidewall portion on an outer side of the carcass layer, and
the transponder being disposed between a position located on an outer side of and 15 mm away from an upper end of the bead core in the tire radial direction and a position located on an inner side of and 5 mm away from an end of the belt layer in the tire radial direction.

10. The pneumatic tire according to claim 9, wherein the transponder is disposed between the position located on the outer side of and 15 mm away from the upper end of the bead core in the tire radial direction and an upper end of the bead filler.

11. The pneumatic tire according to claim 9, wherein the transponder is disposed between a position located on an outer side of and 5 mm away from an upper end of the bead filler in the tire radial direction and the position located on the inner side of and 5 mm away from the end of the belt layer in the tire radial direction.

12. The pneumatic tire according to claim 9, wherein a center of the transponder is disposed 10 mm or more away from a splice portion of a tire component in the tire circumferential direction.

13. The pneumatic tire according to claim 9, wherein a distance between a cross-sectional center of the transponder and a tire outer surface is 2 mm or more.

14. The pneumatic tire according to claim 9, wherein
the transponder is covered with a coating layer, and
the coating layer has a relative dielectric constant of 7 or less.

15. The pneumatic tire according to claim 9, wherein
the transponder is covered with a coating layer, and the coating layer has a thickness ranging from 0.5 mm to 3.0 mm.

16. The pneumatic tire according to claim 9, wherein
the transponder comprises an IC (integrated circuit) substrate storing data and an antenna transmitting and receiving data, and
the antenna has a helical shape.

17. The pneumatic tire according to claim 10, wherein a center of the transponder is disposed 10 mm or more away from a splice portion of a tire component in the tire circumferential direction.

18. The pneumatic tire according to claim 17, wherein a distance between a cross-sectional center of the transponder and a tire outer surface is 2 mm or more.

19. The pneumatic tire according to claim 18, wherein
the transponder is covered with a coating layer, and
the coating layer has a relative dielectric constant of 7 or less.

20. The pneumatic tire according to claim 19, wherein
the transponder is covered with a coating layer, and the coating layer has a thickness ranging from 0.5 mm to 3.0 mm.

21. The pneumatic tire according to claim 20, wherein
the transponder comprises an IC substrate storing data and an antenna transmitting and receiving data, and
the antenna has a helical shape.
